(19) United States
(12) Patent Application Publication
(10) Pub. No.: US 2024/0070323 A1
(43) Pub. Date: Feb. 29, 2024

(54) METHOD AND SYSTEM FOR MODELLING RE-IDENTIFICATION ATTACKER'S CONTEXTUALIZED BACKGROUND KNOWLEDGE

(71) Applicant: KONINKLIJKE PHILIPS N.V., Eindhoven (NL)

(72) Inventor: Fengchang Zhang, Shanghai (CN)

(21) Appl. No.: 18/238,754

(22) Filed: Aug. 28, 2023

(30) Foreign Application Priority Data
Aug. 29, 2022 (WO) PCT/CN2022/115638

(51) Int. Cl. G06F 21/62

(52) U.S. Cl. CPC G06F 21/6254

(57) ABSTRACT

A system and related method for facilitating data anonymization. The system may include a contextualizer (CTX) configured to match, in a matching operation, target attributes of the target dataset (TD) with one or more attributes of data representing a data consumer (DC)'s background knowledge (BK) for the target dataset (TD). As a result of the matching operation, a contextualized data consumer (DC)'s background knowledge is generated, which is representative of the data consumer (DC)'s background knowledge relative to the target dataset. An output interface (OUT) of the system (SYS) provides the contextualized data consumer (DC)'s background knowledge data to an anonymizer (AN) for anonymizing the target dataset.

### CROSS-REFERENCE TO PRIOR APPLICATIONS

This application claims the benefit of Chinese Application No. PCT/CN2022/115638, filed on Aug. 29, 2022. This application is hereby incorporated by reference herein.

### FIELD OF THE INVENTION

The invention relates to a system for facilitating anonymization of a target dataset, to a related computer-implemented method, and to a computer program element.

### BACKGROUND OF THE INVENTION

While releasing microdata gives useful information to data consumers, it presents disclosure risk to individuals whose data are included in such microdata. Microdata may be conceptualized and represented as data table(s). To limit disclosure risk, the concept of privacy models is used, such as the k-anonymity-type privacy model, described by P Samarati and L Sweeney, for example in “k-anonymity: A model for protecting privacy”, published in International Journal of Uncertainty, Fuzziness and Knowledge-Based Systems, vol. 10(5), (2002), pp 557-570. Such models are used in different domains, such as in healthcare domain to protect data leakage of patient data for example. Privacy models allow anonymizing a dataset which is to be released for example. Such anonymizing operations include removal, obfuscation, masking, generalizing or similar of certain data in the dataset to reduce disclosure risk to an acceptable revel as may be defined by the privacy model.

Specifically, in order to apply such k-Anonymity type models, or other privacy models, typically attributes of the dataset to be anonymized are divided into three categories first: i) direct identifiers, ii) sensitive attributes and iii) Quasi-Identifiers (QIDs). Direct identifiers are attributes that are known to explicitly identify individuals on their own, e.g., social security number, name, address etc. Sensitive attributes are attributes that require special control, such as disease type, salary, etc. Direct identifiers and sensitive attributes are usually known outright and may be readily removed from the outset. The third class of attributes, the QIDs, require more involved consideration. QIDs are attributes whose value can be known from other sources. Although those attributes may not be capable of identifying an individual one their own, but when combined, can still potentially re-identify an individual. For example, zip-code, gender, birth date and others. k-Anonymity and other privacy models furnish a mechanism for countering linking attacks using QIDs. Therefore, correctly capturing QIDs is beneficial for safely applying k-Anonymity or other types of privacy models in data anonymization tasks.

### SUMMARY OF THE INVENTION

There may be a need for improved data anonymization. More specifically, there may be a need to more reliably capture QIDs for a given dataset to be anonymized.

An object of the present invention is achieved by the subject matter of the independent claims where further embodiments are incorporated in the dependent claims. It should be noted that the following described aspect of the invention equally applies to the related method, and to the computer program element.

According to one aspect, there is provided herein a computer-implemented system for facilitating anonymization of a target dataset, comprising:
a contextualizer configured to match, in a matching operation, one or more target attributes of the target dataset with one or more attributes of data representing a data consumer (also referred to herein as attacker)'s background knowledge for the target dataset to generate a contextualized data consumer's background knowledge, representative of the data consumer's background knowledge relative to the target dataset; and
an output interface configured to provide the contextualized data consumer's background knowledge data to an anonymizer for anonymizing the target dataset.

In embodiments, the matching operation may be based on a (data) similarity measure.

In embodiments, the matching operation is based on natural language processing. Specifically, the similarity measure may include or use a natural language similarity measure, such semantic similarity measure, or others.

In embodiments, the system further includes a background knowledge model builder, configured to construct a background knowledge model for the target dataset to model the data consumer's background knowledge relative to the target dataset, based on the contextualized data consumer's background knowledge.

In embodiments, the target dataset comprises multiple data tables, and wherein the contextualized data consumer's background knowledge relates to a given one of such multiple data table, and/or to plural such data tables collectively.

In embodiments, the target dataset comprises multiple data tables, and wherein the background knowledge model includes at least one part constructed per one data table, and/or at least one other part constructed per plural data tables.

In embodiments, the system may include a background knowledge relaxation facilitator configured to restructure the contextualized data consumer's background knowledge, based on a pre-defined set of one or more rules. The matched attributes (if any) as may be found in the contextualization operation provides the contextualized (complete) background knowledge data without relaxation. Relaxation of the contextualized background knowledge data may include grouping elements (the QIDs or sets thereof) into knowledge chunks based for example on their closeness (defined by a suitable measure, semantic, NLP, or otherwise) or the said rules established by a de-id expert. When applying a privacy model in anonymization, one may use those knowledge chunks independently rather than in combination. In that way, the contextualized background knowledge data is relaxed, so as not to overestimate attacker's background knowledge which may otherwise result in poor quality (high distortion) of the anonymized target data. Using relaxation allows modelling that attacker's knowledge is in fact limited. The rules may define how the QIDs in the contextualized background knowledge may be combined or what relationships are assumed to hold. Subsets of QIDS may define different knowledge chunks, and the rules may define which knowledge chunks are combinable or other relations between such knowledge chunks.

In embodiments, the system may include the anonymizer itself, configured to anonymize the target dataset based on the background knowledge model or on the contextualized background knowledge. The model may be a unified one. It may include at least one background knowledge chunk as applicable to a chosen privacy model.

In embodiments, the initial data representing data consumer's background knowledge is identified, in first pre-selection or filtering step, by the contextualizer based on at least a profile of the data consumer. The profile may be held in a data library (or other one or more memories) representing background knowledge.

In embodiments, the one or more target attributes are identified by a dataset explorer, based on one or more descriptive quantities that describe a data structure of the target dataset. The data explorer may be part of the system, or may be external to such as system.

In embodiments, the one or more descriptive quantities describe one or more statistical properties of the target dataset, or may provide other “internal context” information (internal to the target dataset). The data explorer may be operable to obtain such context information in relation to one or more of the data tables that make up the target dataset. Context information may relate to data structure, such as semantics (meaning) of a data element), and/or representation (format) of the data element, as required. The data explorer may identify for some or each data table the respective target attributes which are at this point mere candidates of quasi-identifiers (QID). Whether a given attribute qualifies as a target attribute/candidate QID may be calculated based on certain statistic algorithms that process such descriptive quantities of a given one or more data table of the target dataset.

In embodiments, the data representing data consumer's background knowledge is different from the target dataset. Prior to operation of the proposed system, the (initial) background knowledge data is generally not directly linked, or not linked at all, to the target dataset. The initial background knowledge is mainly about different external available data sources, preferably narrowed down based for example on additional information such as on an attacker's profile.

In embodiments, the contextualized data consumer's background knowledge is represented as one or more QIDs. Thus, the matched attributes (if any), optionally but preferably together with the target attributes, form a representation of the contextualized background knowledge data.

In another aspect there is provided a computer-implemented method for facilitating dataset anonymization, comprising:
matching, in a matching operation, one or more target attributes of the target dataset with one or more attributes of data representing a data consumer's background knowledge for the target dataset to generate a contextualized data consumer's background knowledge, representative of the data consumer's background knowledge relative to the target dataset; and
providing the contextualized data consumer's background knowledge data to an anonymizer for anonymizing the target dataset.

What is proposed herein is a computer-implementable system and related method, configured to identify background knowledge data that correspond to the target dataset. Before matching, the background knowledge data (usually some external data, not part of the target dataset) is expected to be broader. After matching, the background knowledge data is contextualized. A subset of the background knowledge data may be used as QIDs (quasi-identifiers) for inclusion into a privacy model for example, and/for building the background knowledge model. The privacy model may be used to define, or implement, anonymization operations to produce an anonymized version of the original target dataset. The anonymized version of the target dataset may then be safely released to the data consumer, instead of the original target data set.

The data matching-based contextualization of background knowledge as proposed herein allows striking a useful balance between assuming, on the one hand, a realistic background knowledge on the part of the data consumer which leads to better data security, and, on the other hand, avoiding overestimating the knowledge the attacker may have which may result otherwise in overly anonymized data, too distorted for useful statistical processing by the data consumer. The matching allows defining QIDs of higher quality, that is, there is a higher likelihood of such matched attributes being rightfully considered QIDs.

The matching operation may use natural language processing (NLP). The matching operation may be based on semantic similarity computing. For example, using NLP technology, candidates of the QIDs can be verified with the attacker's background knowledge as stored in a knowledge base for example. Descriptions of candidate QIDs and descriptions of the attacker's background knowledge may most likely be specified in different terms in natural language. But NLP enabled semantic computing scores the similarity between terms automatically, which will reduce the human efforts (on the de-id practitioner) significantly in certain cases.

Based on the contextualized background knowledge achieved herein by using such data matching, an integrated model of attacker's background knowledge may be built. Such integrated model may cover both, entity level and aggreged level background knowledge. This allows building a better, because more realistic, model of the attacker's background knowledge in real world applications. In addition, knowledge relaxation may also be considered herein as mentioned above, which further avoids unrealistic assumptions about attackers' background knowledge.

Thus, the proposed system facilitates modelling an attacker's background knowledge in a given context. Such modelling may be understood as a mechanism of transforming background knowledge into a computable model for the given target dataset. The representation of the model is preferably via the found QIDs, preferably grouped according to entities (data tables, see below) into sets representing different knowledge chunks, optionally including derived quasi-identifiers, such as those based on statistical results. The proposed system allows overcoming two main challenges in modelling attacker's background knowledge: the first challenge that is overcome is to contextualize the attacker's general background knowledge to the given context (target dataset) using preferably NLP matching or other data matching operations. The second challenge that is overcome herein is the more refined modelling of the so obtained contextualized attacker's background knowledge for the target dataset, especially, if the target dataset is a multi-relational dataset. Thus, the background knowledge may be modelled herein on plural levels, including data table (“entity”) level and “aggregated” level. Aggregated level relates to the modelling of relationships of quantities that are derived from one or more data tables of the target dataset. Entity level modeling relates to modeling of a given one or more table in the target dataset. This multi-level modelling further affords a yet more precise and realistic background knowledge modeling, which in turn yields higher quality (for example, less distorted) anonymized data. Multi-level background knowledge modelling allows representing background knowledge in the above-mentioned knowledge chunks. This allows modelling of the background knowledge at a finer level or granularity, as data consumer may be assumed to be aware of some such data chunk(s), but not of other(s), for example.

Thus, the contextualizing of attacker's general background knowledge to a given context (target dataset) is preferably based on i) a background knowledge repository, which in turn may be based on one or more profiles of attacker and on external sources, and ii) the semantic similarity computing mentioned above.

Without the proposed system and methods, contextualization is a time-consuming and expertise dependent task which leads to inefficiency and inconsistency when performing de-identification based on k-Anonymity or similar privacy models. Without the proposed system and methods, due to a lack of a well-established attacker's background knowledge base in an institution, a de-id (de-identification) practitioner may spend much time on exploring how much background knowledge data consumer can be assumed to have. In addition, different de-id practitioners might have different perceptions on the attacker's background knowledge, which leads to different decision-making on identifying quasi-identifiers for the same case for example. Manually matching data elements specified in the data structure of the dataset to background knowledge can also be a tedious and expensive task for de-id practitioners, because specifications and knowledge may be described in natural language which may require significant efforts, especially for a high dimensional dataset. The proposed system and method allow addressing some or all of such challenges, in an efficient, well-defined, rational, and standardized manner.

The proposed modelling of attacker's background knowledge based on the proposed contextualization in respect of the target dataset, allows for a better understanding of characteristics of the target dataset. Previous efforts had attempted building a unified model for a whole given dataset. However, this usually leads background knowledge attacks being overlooked. For example, Ku-Anonymity privacy modeling tends to oversimplify attacker's background knowledge, in particular in relation to transactional data tables, by suppressing the whole row into a description of an item. The proposed modelling based on contextualization allows addressing such oversimplification because modeling the background knowledge at multiple levels (entity level and aggregated level) will make sure each table will be modeled precisely, and also aggregated knowledge (derived knowledge) will be accounted for in the model.

In yet another aspect there is provided a computer program product comprising a computer readable medium, the computer readable medium having computer readable code embodied therein, the computer readable code being configured such that, on execution by a suitable computer or processor, the computer or processor is caused to perform the method.

In other aspect, the computer program product merely includes the computer readable code.

In yet another aspect there is provided a use of the contextualized data in anonymizing a target dataset and/or in building an attackers/data consumer's background knowledge model.

“(Data) table” is part of a dataset that may be stored in a data storage. Data table is used interchangeably herein with “(data) entity”. The table preferably represents structured data in the same dimension (same set of “attributes”) of data subjects. The dataset is said to be multi-relational if it includes multiple different data tables. Multiple tables are capable of expressing relations of multiple data dimensions for data subjects. Data subjects can be said or have multiple dimensions, and each dimension consists of multiple attributes or “data fields”. Attributes or “data elements” may be used interchangeably with data fields. Each “attribute/”data field” may hold a data value. Data values of a particular dimension may be referred to as a datapoint or record. Such datapoint may describe a data subject (such as a patient). Datapoint may be represented as a point in a suitably dimensioned vector space. A proximity or distance function may be defined between datapoints. A data table may be stored or may be associated with a matrix structure having one or more rows and one or more columns. Plural rows and/or plural columns are common. Multiple rows may form a data table. A column represents a respective “data field” across data subjects. A row may be referred to as a record. A record or row relates generally to data of a data subject. Alternatively, although less common, a record may be stored as columns and data fields in rows. One data table may be said to differ from another if it includes different data fields. A dataset as envisaged herein may be held in a database, such as relational database system, or in particular in a multi-relational database system, although other manners of storage and management are not excluded herein. The dataset may be stored or arranged as a collection of data files in any suitable format such as a text file, separator-structured data file (such as in csv (comma-separated-values), in spreadsheet format, etc. The dataset is preferably structured. If unstructured, the dataset may be converted into a structured format. “(Single) dataset release” relates to plural, such as all, data tables in the dataset released together as a whole to a data consumer.

“Data subject” is a natural person (e.g., patient) to whom the data in a record pertains.

“Data point” relates to an observation of a data subject, usually represented by a row/tuple in a data table.

“Attacker/data consumer” relates to an entity to whom the dataset is released, either intended or not. Such entity is in general not the owner or publisher of the dataset.

“Direct identifier (ID)” are attributes that allow uniquely identifying a data subject or data point.

“Quasi-identifier (QID)” are one or more attributes that allow identifying a data point when taken together with attacker background knowledge or other QIDs, but do not allow uniquely identifying such data points on their own. Such identification via QID(s) may be unique, but this may not be so necessarily as a mere graded identification in terms of probabilities, or other scores, is also envisaged herein.

“Privacy model” is a set of requirements that allow objective quantification of a desired privacy level/leakage or de-identification risk. For example, the set of requirements can be integrated in a model to facilitate anonymization of a dataset. The privacy model controls the amount of information leakage that may be drawn from the held dataset. The privacy model may allow measuring privacy levels using functions or parameters. The privacy model may include criteria (such upper bounds etc.) on acceptable/inacceptable data leakage/de-identification risk.

“Anonymizing (operation)/Anonymization” may include suppression of one or more records or individual one or more data field(s) a data table. Reversal (which is undesirable) of anonymization is called re-identification (“re-id”). Anonymization may include in general replacing the original data by replacement data. The replacement data may represent some property or the original data, but provides less information than the original data it replaces. Some statistical properties of the original dataset may thus be at least partly preserved in the anonymized data. Anonymization operation makes the original data inaccessible to a data consumer. Anonymization operation may avoid, or reduce the risk of, re-identification of a data subject. The risk corresponds to the privacy level as per the privacy model. Anonymization operation may include suppression of one or more records or suppression/modification of one or more individual data fields (parts of a record). Thus, an anonymization operation may be based, or act on, a record as a whole, or per data field. For example, in some privacy models, a group of records that are found to include matching quasi-identifier may be suppressed as a whole. An anonymizing operation may thus record/group-wise on the table or across multiple tables. Anonymization in respect of a data table may relate to applying a privacy model on the whole table. According to different privacy models, an outcome of which data is anonymized may be different. In general, anonymizing a table (that is, applying a privacy model in respect of the table) and anonymizing individual data fields are independent operations. In practice, the privacy model is applied first to the whole table. If a record attracts a lower score/probability as prescribed by the privacy model, such a record is deemed high risk and is subjected to anonymization operation. If needed, individual data fields may then be anonymized in a second step.

“k-anonymity” is an example of a specific privacy model, and a class of related privacy models. Such models may rely on the concept of QIDs, like, age, gender etc. k-anonymity modelling includes finding a group of records in the whole table, in which all the records share the same data value combination of the identified QIDs for this table. Such records may form an equivalence class in respect of this model. As per the k-anonymity model, as size of the equivalence class (EC) is established, eg., by counting the number of unique data subjects within each group/EC. Any group/EC with a size smaller than the predefined k-threshold of unique data subjects will be subjected to anonymization operation, such as suppression or generalization or other, as required. The k-threshold is a whole number and forms a parameter of the privacy model. k-anonymity model was described by the paper of Sweeney et al cited above.

The terms “data consumer”, “attacker” or “(data) recipient” are used interchangeably herein.

“background knowledge (data)” or “data representing background knowledge” includes data, structured or unstructured, that an data consumer can be assumed to be aware of. The background knowledge data may include or represents attributes, optionally relations between such attributes. The background knowledge data may include a text corpus. The background knowledge data may be stored any data storage such as a database system, on a webserver, data library, etc. The background knowledge data may be public domain data.

“profile (data)” of data consumer may include any data that allows drawing conclusions on the type, nature and extent of data consumer's background knowledge. Such data may be in public domain. Profile data may pertain to data consumer's interests, activities, etc. Such data may be found in social media account or in any other publications such as report, articles, webpage entries, etc, that pertain to the data consumer.

“(attackers/recipient's/consumer's) background knowledge data model” may be represented as one or more discrete data structures built from QIDs. Such discrete data structures may include tuples, tree, graphs. Each data entity may be represented by one or more such discrete data structures, and the manner in which such discrete data structures may be combined or their logical or other relationship may define an aggregated level background knowledge model for the attacker/recipient/consumer. This allows more precise (because more granular) definition of background knowledge model.

### BRIEF DESCRIPTION OF THE DRAWINGS

Exemplary embodiments of the invention will now be described with reference to the following drawings, which, unless stated otherwise, are not to scale, wherein: —

FIG. 1, shows a schematic block diagram of a data anonymization system;

FIG. 2 shows a background knowledge processing component as may be used in or in conjunction with the system of FIG. 1;

FIG. 3 shows components of the background knowledge processing component of FIG. 2;

FIG. 4 shows a flow-chart of a computer-implemented method of facilitating data anonymization; and

FIG. 5 shows a flow-chart of a method of anonymizing a target dataset based particular on output provided by the method of FIG. 4.

### DETAILED DESCRIPTION OF EMBODIMENTS

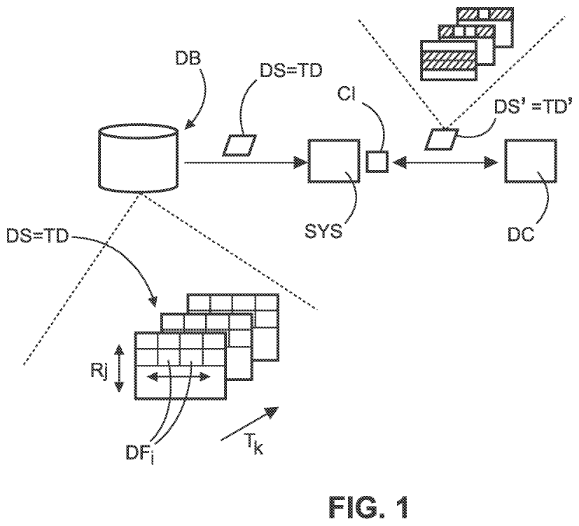

With reference to FIG. 1 there is shown a schematic block diagram of a computer implemented system SYS configured to anonymize or de-identify (both terms will be used interchangeably herein) an original dataset DS as may be held in one or more data storage systems, such as data base systems DB or the like.

The dataset DS to be processed for anonymization by system SYS may be a multi-relational dataset, preferably held as multiple (data) tables Tₖ in a storage, such as a relational data base system, in particular, and in some embodiments, in a multi-relational database system.

Generally, anonymizing the dataset DS includes processing the dataset DS using one or more anonymization operations to effect such anonymization. The result of such processing is an anonymized version DS' of the original dataset DS. Such anonymization allows avoiding that individual data subjects, whose data is represented in the dataset DS, can be identified by an interested party such as a data consumer DC, also referred to herein as an “attacker”. In general, data consumer DC is any party that wishes to process the dataset, but are not in general owners of the dataset DS.

In a medical setting as mainly envisaged herein, the dataset may relate to health records of various patients in one or more medical facilities, such as may be held in a hospital information system (HIS) or in a picture archiving and communication system (PACS). The dataset DS may include, for some or each patient, data items such as medical reports, image data, laboratory data, etc. In addition or instead, the dataset may include data items that relate to various bio-characteristics of individual patients, their respective health status, biographical data, biophysical data, and others. Some of this data may be of confidential nature (sensitive data). It is the anonymized dataset DS′, instead of the original dataset DS, that may be released to data consumer DC. The anonymized dataset DS' safeguards patient's interest. Leakage of sensitive data, or of data that may allow identifying a given individual patient, is avoided, or is at least made less likely thanks to the released anonymized data DS′.

Whilst cryptographic processing is one way to protect data from leaking to unauthorized parties, in certain data consuming examples (one which more below), cryptography may not be useful as the data becomes unusable for data processing systems without prior decryption.

The system SYS addresses this problem by providing a tradeoff: system SYS is configured to apply anonymization operations to the original dataset DS to provide the anonymized dataset DS′. In this anonymized dataset DS′, certain aspects of the original data are protected, and yet the anonymized data is still of use to the data consumer DC. Specifically, the anonymizing operation as implemented by system SYS modifies the initial dataset DS in a manner to prevent, or make unlikely, that data subjects (e.g., patients), to which the dataset DS relates, can be uniquely identified. At the same time, the applied anonymizations are such that statistical, collective information, such as statistical relationships, patterns etc, within in the original dataset DS are, to a sufficient degree, preserved in the anonymized/modified set DS. The anonymized/modified set DS' is hence still useful for data consuming tasks by the data consumer DC, for example of the sort to be outlined in the following. The anonymized dataset DS′, once released to data consumer DC, may reveal upon processing useful statistical information or insight in terms of useful patterns or useful relationships that can be used by the data consumer DC for certain medical task(s). A range of different data consuming tasks by data consumer DC (or other data consumers) may be envisaged in the medical field. One such data consuming task may include training a machine learning model based on the dataset. For example, the machine learning model may be trained for automatic diagnostics, such when classifying image data for presentation of a certain class of disease of interest. The dataset preferably relates to a large number of patients, and may include not only imagery (such as X-ray or of any other modality), but also contextual data. The dataset may thus facilitate robustness of the trained machine learning model. Other types of machine-learning applications envisaged herein may include training, based on the dataset DS′, a machine learning model to control a medical device such as an imaging apparatus, a contrast agent pump, a radiation delivery apparatus (eg, a linac), or any other medical device. Other data consuming applications of the dataset may include use in “virtual” drug discovery to discover suitable bio-markers, or for other medical analytics or medical data mining applications geared to find such patterns or relationships for a range of medical objectives. In sum, consumption of such medical patient dataset DS' could be used to facilitate or implement an efficient health care system, thus driving down costs, increasing patient throughput with less waiting times, and better quality, to the benefit of most.

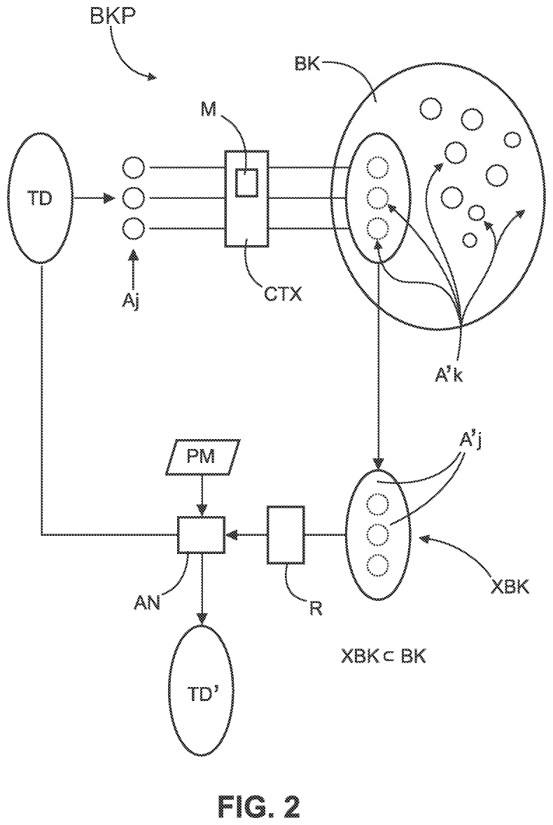

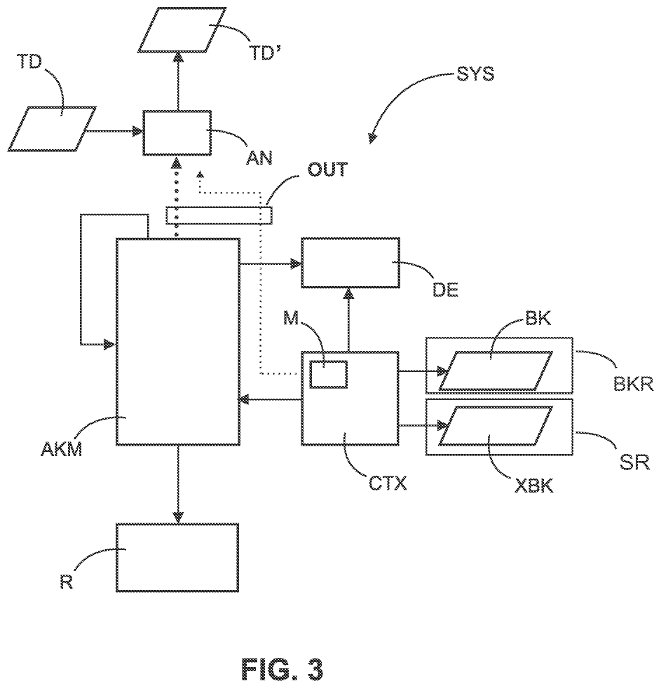

The improved anonymization operations as afforded by the proposed system will be explained below at FIGS. 2-3 in more detail.

The dataset DS when modified by the anonymizer system SYS may be provided as a copy of the anonymized data DS' to the data consumer DC, either by transferring the dataset DS's via a communication channel to the consumer DC, or by other means, such as by granting remote access through a suitable query interface to the modified data DS′. No access however is provided to the original dataset DS. Such access schemes may be implemented in an off-line embodiment, where the anonymization by system SYS of the original dataset DS (which results in the modified dataset DS′) is done before a request for the data by consumer DC is received. The data consumer DC may not always be benign, but may wish to hack into the system by penetration. In such cases, it may be useful to ensure that only the modified dataset DS' may be accessible, even after such penetration.

Other embodiments, such as on-line embodiments, are also envisaged herein, where the data anonymizing system SYS is implemented as a middleware layer. The middleware layer may be arranged communicatively in-between a data base system that hosts the original dataset DS, and the access requesting party DC. For example, data consumer DC may issue through suitable query interface a search query to the data base to be applied to dataset DS. The search query is intercepted by a suitable communication interface CI of the system SYS, and the anonymizing operation is done in response to such a query. A suitably anonymized part of the dataset that respects the query may then return to the querying party, such as data consumer DC.

The system SYS may be implemented in one or more computing systems or units PU. For example, data anonymizing system SYS may be arranged in a Cloud or distributed architecture where functionalities of the system may be distributed among plural computing systems, suitably connected in a communication network. However, the system may also be implemented on a single computing system PU, if desired.

Referring now to the inset in FIG. 1 at the lower left, the original dataset DS may be stored in data storage DB. The original dataset DS may be stored or may be processable as the said plural tables Tₖ. Each table Tₖ is made up of plural records Rⱼ. A given records Rj may represent data of a respective data subject, such as a patient j. Each record Rⱼ in turn may be made up of plural data fields DFᵢ, each representing a certain attribute of data subject j. Each data field DFᵢ may have a certain attribute value from an attribute domain stored. The attribute value represents an instant of the attribute for that patient j. For example, one data field may represent the age of a patient j, with a numeric value, such as a whole number, e.g. ‘45’, indicating that patient j is 45 years old, etc.

The said data tables Tₖ, including the records Rⱼ versus data fields DF; structure, may be presented, stored, and/or processed as a respective indexed data structure, such as a matrix structure, whose rows and columns represents the respective table Tₖ. For example, records Rⱼ may be represented as rows, and data fields DE as columns. However, such an arrangement is just an example of convention, as rows may be represented instead as data fields, whilst records are in rows, as desired. However, representing records as rows is a common convention and will be used herein throughout, but, as said, this is not limiting. A data table is said to differ from other data table if one of the tables has a data field/attribute type that is not a data field of the other data table. In multi-relational dataset settings, different tables may be processed together, such by combination in a database join operation using some data field(s) as a common key, so that relations between two (or more) data tables can be represented.

Broadly, the anonymizer system SYS takes as input some or all of the original dataset DS, including the one or more data tables Tₖ, and produces, based on this input, the modified dataset DS' as output. Output of anonymization operation is illustrated as hatchings in the upper right-hand side of FIG. 1. For example, as a result of the anatomization operation, one or more rows and/or one or more distinct data fields (if not the whole row) in one or more data tables of the original dataset DS is made inaccessible to a third party, such as data consumer DC. Making data (that is, a row or distinct data field(s) on its own) in a data table inaccessible may include applying a data modification operation. Such modification may include deletion, obfuscation, suppression, generalization, and others. Such modification operation may relate to a given row as a whole, or to distinct data field(s), possibly with gaps. For example, for two or more suppressed rows there may remain one or more original data rows in-between, or for two or more suppressed data fields there may remain one or more original data fields in-between. As another example, an entire one or more rows may be suppressed, or one or more data fields in a row are suppressed, with some original data field (s) remaining in that row. Modifications may include hashing the entire row or only certain distinct data field(s) therein. The original values may be substituted by certain symbols to obfuscate the original data values. Data values in a given one or more data fields may be shifted, by adding or subtracting certain values, such as noise, etc. Generalizing data values in a data field is another form of obfuscation. Generalizing data values may include substituting the respective data values with a large range or interval that includes the data to be anonymized. Any other manners of making data inaccessible are envisaged herein, the foregoing being examples which can be used either singly or in any (sub-)combination, as required.

The anonymization operation(s) is to protect original data. The original data in dataset DS is prevented from leakage to data consumer or other non-owner of the dataset, or likelihood for such leakage is reduced. This safeguards privacy of the data subjects whose data is in the dataset DS.

Anonymization is based on a privacy model PM=m. The privacy model m is a specification that describes the manner or other details of the level of privacy (or leakage protection) that is to be achieved by the anonymization operation(s). The privacy model m may be formulated as a set of conditions for elements in some suitable space, such as discrete space or continuous space. The elements may relate to data fields or rows. In one embodiment, the privacy model m can be implemented as a computing model to implement or represent the abovementioned specification and/or conditions. Applying the privacy model to the dataset DS to be anonymized may include solving an optimization problem in terms of an objective function to find the rows/data fields that need be anonymized to meet the conditions as per the privacy model. Graph-theoretical representation of the tables may be used, with discrete optimization procedures to find the fields and records that need to be anonymized. Applying the privacy model maybe includes computing a leakage or re-identification (“re-id”) risk per data row or data field. Those rows or data fields that attract a respective pre-defined risk level (for example, expressed by a score, such as p % or other) are then subject to anonymization, such as suppression, generalization, obfuscation, etc. Thresholding may be used to define the pre-defined risk level.

Thus, the privacy model m may allow quantifying the leakage risk per record in a given data table in terms of a score, such as a probability. Optionally and preferably, an overall leakage risk may be computed for the whole given table. This per table leakage risk may be computed based on the per record leakage risks. Some privacy models such as k-anonymity are based on QIDs, a special class of attributes that allow identifying a data subject when taken in combination. Equivalence classes among rows of a given table may be defined. Two records are in the same equivalence class if they share the same QID attribute values. Some privacy models, such as k-anonymity, specify that are at least k records to remain in each equivalence class. Thus, the re-id risk is 1/k. Other privacy models may specify other scores or probabilities to quantify the re-id risk per record. The scores may code differently for high risk, depending on convention. For example, a high score in terms of magnitude may indicate high or low id-risk, as the case may be.

Other privacy models envisaged herein include, in addition to the k-anonymity model mentioned above, KM-anonymity, t-closeness, etc. Some privacy models may be parameterized such as k, KM, or t in the above examples (note, parameter k in “k-anonymity” or on other privacy models is not related to generic index k of data tables Tₖ as used herein). A privacy model as understood herein differs from another when the conditions required by both differ. A privacy model may be conceptualized as made of model elements. A choice of different elements for a given model type may be considered herein as different privacy model instances.

Some privacy model elements may include one or more of: the given table, a selection of QIDs, and one or more model parameters. The model parameter(s) may facilitate defining the de-id risk in the framework of that model as illustrated above for the k-anonymity model.

An effect of such privacy models, such as k-anonymity or others, may be understood in terms of query operations on the anonymized dataset DS′: data consumption by data consumer DC of anonymized dataset DS' may involve running a data mining operation, such as a search query, against the anonymized dataset DS′. The query may be implemented in SQL for example, or in any other query language, or any other data mining operation may be used. The query results in output which represents data that complies with the formulated query. Because of the anonymization applied to the dataset DS to obtain the modified dataset DS′, each or substantially most queries will result in output including plural data records Rj, so that no query will result in returning a single such record that may potentially allow (preferably uniquely) identifying a data subject whose data includes the retrieved data points. The minimum number of hits returnable for each query, or the probability for this to happen, may be prescribed by the underlying privacy model. For example, in k-anonymity, the anonymization operations are so applied to the initial dataset that there always at least k records being returned, or at least that this is ensured in at least p % of cases, with p a confidentiality threshold that may be chosen suitably by user, such as p=95 for example. Such a confidentiality threshold may also be defined for privacy models other than k-anonymity.

The system SYS as envisaged herein may thus include an anonymizer stage AN and a background knowledge processor stage BKP as shown in the block diagram of FIG. 2. The anonymizer stage AN applies anonymization operations to the dataset DS to computed an anonymized version DS' of the initial dataset DS as described above. The dataset DS may thus be referred to hereinafter as the target dataset TD. The anonymization operation may be based on the (on or more) privacy model. However, for present purposes the anonymizer stage AN may be optional and may be external to system SYS.

As mentioned above, the privacy model PM allows for example to compute a score for a given attribute field or a record as whole for tables of the dataset TD. The respective score can be used to establish which field or record of a table of dataset TD should be subjected to anonymization operation. Preferably, the anonymization operation is not only based on the target set TD, but is also based on additional data BK that represents background knowledge of an attacker, such as of the data consumer DS. The background knowledge processor stage BKP provides such external background knowledge data in manner described on more detail below. Using such external data BK is beneficial for privacy models, as is envisaged herein, that rely on the concept of quasi-identifiers (QID). Direct identifiers and/or sensitive data (preferably both) are removed outright by anonymizations operation. QIDs on the other hand are other attributes that may not be identifiers in an off themselves, but that allow nevertheless re-identification of a data subject when combined with other attributes, as mentioned briefly above. Establishing which attributes in the dataset are QIDs is hence beneficial to avoid, or reduced the risk of, data leakage. Whilst some QIDs may be found based on certain metrics that may be computed based on the target dataset TD themselves, the anonymization becomes more secure if external data BK (different from the target dataset) is taken into account. The external data BK represents knowledge which the data consumer DC may be assumed to have. The external data may be for example a voters registry database, whilst the target dataset TD may hold patient data of a medical facility. Certain public domain data may well be assumed to be part of data consumer DC's knowledge. Other data, although public domain, are less likely to be part of consumer's DC's background knowledge. Considering only external data that is likely to be part of the data consumer's knowledge is beneficial as this facilitates a more realistic modelling of the background knowledge of data consumer DC. Such realistic background knowledge modeling allows establishing a more robust set corresponding set of QIDs, which in turn yields an anonymized dataset TD′ of higher quality. The anonymized dataset TD′ is of higher quality if it includes less undue distortion (such a degradation of information content), and that still provides a sufficient level of protection against de-identification risk. The proposed system SYS allows identification of QIDs that correspond well to the background knowledge of the attacker and the target dataset TD. Specifically, the system allows contextualizing existing external data to the target dataset. In other words, the target data TD can be thought to provide context of data consumer's knowledge. An external dataset BK that can be identified to correspond to that context can thus be said to be contextualized relative to the target dataset TD.

Thus, the background knowledge processor BKP processes the external data BK, and attempts to contextualize same relative to target dataset TD. Thus, the background knowledge processor BKP operates to find data that correspond to the target dataset TD for use by the anonymizer stage AN. It is the so found data that, together with the target dataset TD, can be used to compute an extended, and yet more realistic, range of QIDs on which the anonymizer stage AN can operate. The extended QIDs can be included in the privacy model used by anonymizer AN to ensure that the right data in the target dataset is anonymized.

Broadly, the background knowledge processor BKP may first identify suitable candidate data, such as external datasets, for example voter registries or other generally public domain information, that corresponds to knowledge that the data consumer/attacker DC can be reasonably assumed to have. A profile of the data consumer DC, such as a statistical attacker profile may be used to so identify suitable datasets as background knowledge. Once so identified, the background knowledge data BK is then contextualized relative to the target dataset TD, as mentioned above.

Operation of background knowledge processor BKP is illustrated in more detail with continued reference to the block diagram of FIG. 2.

Optionally, based on a statistical analysis of the data structure of the target dataset TD, a potential set of quasi-identifiers Aⱼ, referred to herein as candidate QIDs, is established. The candidate QIDs are a subset of attributes Aⱼ of the data target dataset TD, which may hence also be referred to herein as target attributes.

The knowledge processor BKP may include a contextualizer CTX. The contextualizer CTX may be implement or include a data matcher M. The matcher M of contextualizer CTX attempts matching the candidate QID of target dataset with one or more attributes A′k of data that represents background knowledge BK. This background knowledge BK data may have been previously identified based on the profile of the data consumer DC. Thus, the identification may proceed in a two-step approach: in a first step, the profile is used for a “coarse” identification of potential data that may be considered background knowledge for the consumer DC. In a second step the so coarsely identified data may then be contextualized by data matching to find QIDs.

The matcher M may use string matching, such as regular expressions with wildcard expansions or simpler types of string matching, or any other string-matching mechanism. For example, string “SEX” in target set TD may be matched against “GENDER” in the background knowledge BK data to find corresponding attributes across the target set and the background knowledge data that relate age of data subjects.

Preferably, instead of, or in addition to string matching, a natural language processing (“NLP”) pipeline is used by matcher M. Thus, a semantic matching may be used, capable of finding attributes in the background knowledge set BK that correspond in meaning to the candidate QIDs established in the target dataset TD. The background knowledge data BK may be unstructured or structured text data. If unstructured, the NL processing may for example find predicates in text portions of the background knowledge BK. The predicates represent attributes that can be matched against one or more candidate QIDs of the target dataset TD.

The NL processing may be based on machine learning (“ML”) models, previously trained on a language corpus. The ML model may include neural network (“NN”)-type architectures, such recurrent networks. Encoder-decoder type networks may be used. In some embodiments, self-attention techniques may be used. The NL pipeline used by matcher M may be based for example on BERT-type networks or other transformer-based models. BERT-type architectures are described by J Devlin et al in “BERT: Pre-training of Deep Bidirectional Transformers for Language Understanding”, published online, arXiv:1810.04805, https://doi.org/10.48550/arXiv.1810.04805, first posted 11 Oct. 2018, revised 24 May 2019. Other NL processing models preferably capable of semantic analysis (semantic similarity in particular) are also considered, and the present disclosure is not limited to the above-mentioned ML examples. Matcher M may use any natural language similarity measure. For example, candidate QIDs and attributes in background data BK may be mapped into vectors of a vector space. Term frequency-inverse document frequency (“tf-idf”) vectors may be formed. In some embodiments, embeddings may be used to effect such as mapping. The embeddings may be implemented themselves by ML techniques, such as neural networks, by dimension-reduction techniques more generally, or probabilistic models, etc. Similarity across attributes may be measured in the said vector space by using Euclidean-based distance of the component-wise difference between the corresponding vectors in the said vector space. Other p-norms such as in LP-spaces may be used instead of the Euclidean norm/distance to measure similarity. Statistical NL processing models or techniques can be used. Other similarity measures envisaged herein may include Edit Distance, Cosine similarity, in particular with tf-idf vectors, or others.

Thus, whichever technology is used to implement matcher M, candidate QIDs Aⱼ are initially established based only on information contained in the dataset TD. But with the matching operator M, the semantics of the said candidate QIDS Aⱼ is extended or “projected” into the background knowledge data BK to find similar attributes that are likely to allow an attacker/data consumer DS to establish a link between the quasi-identifier's QID and other information held in the background knowledge. It is only when a such matching attributes are positively found in the background data BK that the combination of the candidate QIDs Aⱼ and the matching attributes A in the background knowledge dataset BK may be collectively referred to, now properly, as QIDs (the qualifier “candidate” may then be dropped).

Matcher M may thus conceptualize a contextualizer, operable to contextualize the background knowledge by identifying attributes therein that matches certain type of attributes (the candidate QIDs) in the target dataset TD. The matching attributes in the background knowledge data may be understood as a subset XBK of attributes A′ⱼ of all attributes A′ₖ in the background knowledge dataset BK. The matched attributes A′ⱼ in the background knowledge data BK may form a model of the data consumer's DC background knowledge data BK, or may be used to build a more refined model of the data consumer's DC background knowledge. Thus, the subset XBK of attributes may be understood as the result of the contextualization operation. The subset XBK represents the contextualized background knowledge of attributes found to represent, or with high likelihood represent, QIDs for the target dataset TD.

The subset XBK may be passed on through an output interface OUT to anonymizer AN stage and/or to model builder AKM. Model builder AKM may be part of anonymizer stage AN. Subset XBK may be used by anonymizer AN. For example, subset XBK may be included or otherwise used in connection with anonymizer AN's privacy model. A respective score of fields and/or records may be computed, based on the privacy model to established which fields and/or records or dataset TD need to be anonymized. The anonymizer AN may apply anonymization operations to the target dataset TD based on the scores to compute the anonymized version TD's of the original dataset TD. The anonymized version TD′ may then be released to data consumer DC for processing, such as for statistical analysis, for building a training dataset for ML, etc.

There may be an optional knowledge relaxer R that may subdivide the attributes A′, in XBK into knowledge chunks which can then be processed separately by a privacy model to define elements in the target dataset that need to be anonymized by anonymizer AN. The anonymizer AN may then apply these operations to obtain the anonymized target dataset TD′ which can be released to the data consumer.

The contextualized background knowledge set XBK includes the previous candidate QIDs Aⱼ of the target dataset TD, and the matching attributes A′ⱼ in the background knowledge BK set. Thus, by accounting in the application of the privacy model to information contained in the target dataset TD (the previous candidate QIDs) and the matching attributes A′ⱼ in the background knowledge BK, the data consumer's knowledge is more realistically accounted for by the privacy model. In other words, unnecessary distortion of the anonymized target dataset for release to the data consumer can be avoided, and yet a sufficiently high privacy protection defined by the privacy model can be provided.

The above-described operations of background knowledge processor BKP can be applied to a single table in the target dataset TD or may be applied collectively to plural such tables, in particular all tables, in the dataset TD. In particular, a multi-background knowledge model BK may be built by repeating the above-described background knowledge contextualization operations separately, to some or each, data table in the target dataset or to subsets of such data table. This results in respective, different contextualized sub-sets XKB, each constructed for a different subsets of data tables in target dataset TD. This multi-knowledge analysis/modelling allows for a more granular approach where expended CPU time can be balanced against security needs.

Reference is now made to FIG. 3 which provides more details of the above-described system of FIG. 2. In particular, an inter-operation between anonymizer AN and in particular the background knowledge processor BKP is explained in more detail. As the proposed system may often be used in a hostile environment, the data consumer DC will be also referred to herein as the “attacker”, with both terms used interchangeably herein. Broadly, the system SYS may include the following components, although some components are optional as will be described below in more detail: an optional dataset explorer DE, the background knowledge processor BKP including i) contextualizer CTX using matcher M and ii) an optional attacker's background knowledge modeler/builder AKM. The system SYS may further comprise optionally: i) a background knowledge relaxer R, ii) a background knowledge repository, base or other memory BKR on which is stored attacker's background knowledge data BK, and ii) a semantic repository SR.

Optional dataset explorer DE is operable to establish, based on information internal to the target set, a potential QIDs Aj, that is, the candidate QIDs. The data explorer is optional as in some cases the candidate QIDs may have been designated already, such as by user, or are otherwise given.

The data explorer DE may operate to collect descriptive information, such as data structure, number and/or size of equivalence classes among some or all attributes of a given table, of plural tables or of all tables in the target dataset TD. The descriptive information may include statistical results about the data structure of target dataset TD. In order to better represent the said data structure, dataset explorer DE may optionally organize the descriptive information in two levels, on an entity level and on a data element level. Therefore, the data explorer DE may provide descriptive information such as how many entities are represented by data in the target dataset and/or what are the data elements (attributes) for each particular entity. In general, the descriptive information is based solely on information internal to the target set TD. The dataset explorer DE may use the descriptive information to compute from among all attributes in set TD, the ones Aⱼ that may potentially be considered QIDs, the candidate QIDs that is. The so established list of attributes Aⱼ may then be passed on as a set of candidate QIDs to contextualizer CTX. The candidate QIDs may be associated with the respective data entity to which each candidate QID pertains.

As mentioned in FIG. 2, contextualizer CTX may act as a QID-recognizer or verifier. The contextualizer CTX is operable to establish, based on set of candidate QIDs in target set, proper QIDs for some or each entity in the target dataset TD. This may be established by matcher M attempting matching the candidate QIDs in the target dataset TD to attributes of the attackers' background knowledge data. The attackers' background knowledge data may be stored in one or more data storages, repositories, etc, different from and/or external to dataset TD. Semantic computing may be used to establish semantic similarity between candidate QIDs and the attributes in the attackers' background knowledge data BK as mentioned earlier. Once such similarity is deemed sufficient, such as ascertainable through thresholding for example, the candidate QIDs may be said to be proper QIDs.

Optional attacker's background knowledge base BK manages and maintains relationships between attackers' profile and the knowledge managed within the semantic repository SR. The profile may be used to locate suitable background knowledge data BK. A statistical profile may be used that allows locating suitable background knowledge data that the attacker DC is more likely to be aware of than other such data.

Optional semantic repository SR may be implemented as central or distributed data storage for managing and maintaining knowledge about accessible inside and outside datasets. This knowledge may include the information about the target population, data structure (including data elements), statistical summary etc. The subset XBK of matched attributes may be stored in the semantic repository SR.

The optional Attacker's Background Knowledge Modeler AKM may be operable to build an integrated attacker's contextualized background knowledge model based on the contextualized background knowledge found by matcher M. In order to model the contextualized background model at a sufficient level of precision, two levels of background knowledge maybe considered, namely entity level and aggregated level.

The optional background Knowledge Relaxer R is configured to estimate how much background knowledge a given attacker DC can be assumed to have in a particular context (target dataset and/or environment). One way to relax background knowledge is by quantifying the background knowledge and setting appropriate upper bounds (thresholds). The method of quantifying the background knowledge may be dependent on the characteristics of a given entity of the target data set TD, and, optionally, also on the profile of the data recipients DC. For example, for data tables, transactions, etc, quantifying methods/statistics can be used. The QIDs may be divided into knowledge chunks, and the privacy model PM may be applied separately for each such chunk of data as mentioned above, and as will be described below in more detail.

Knowledge Relaxer R and Semantic Repository SR may be separated from the Attacker's Knowledge Modeler AKM and/or from the Attacker's Background knowledge storage BKR, respectively. In the alternative, Knowledge Relaxer R and Semantic Repository SR may be integrated into the Attacker's Knowledge Modeler AKM and/or into the Attacker's Background storage BKR, respectively.

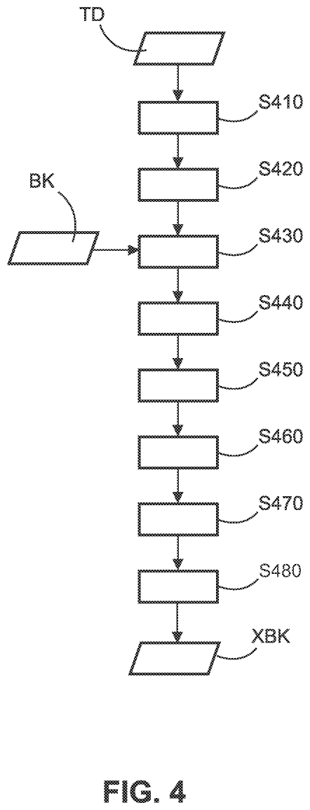

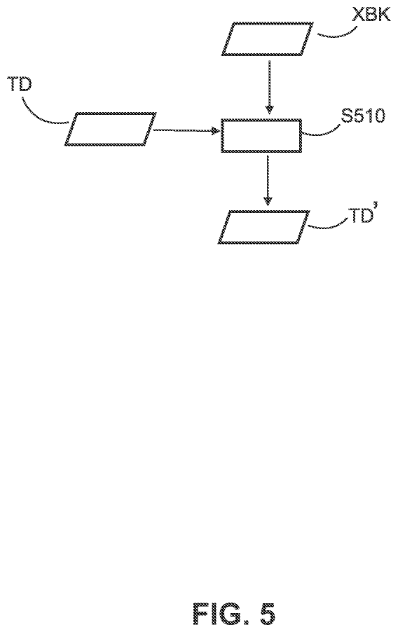

Reference is now made to FIGS. 4,5 which show a flow-chart of a computer-implemented method for facilitating data anonymization for data privacy protection (FIG. 4). In particular, FIG. 4 shows a flow-chart illustrating steps of the above-described background knowledge processor stage BKP, whilst FIG. 5 relates to the anonymization operation AN itself. Thus, the background knowledge processing steps in FIG. 4 may be understood to facilitate the subsequent anonymization operation in FIG. 5. The anonymization operation may be based on a privacy model PM. The privacy model may rely on the QID concept on which thus the anonymization operation may be based. However, it will be understood that the below described steps in FIGS. 4/5 are not necessarily tied to the architecture described above in FIGS. 1 through 3.

At step S410, one or more data tables in the target dataset TD are received or accessed, otherwise identified.

At step S420, descriptive information of the target dataset globally, or locally, of one or more tables is captured. The descriptive information may provide internal context information. The descriptive information may describe data structure of the target dataset globally or locally. The data structure so described may be grouped by entities. Step S420 may include analyzing the dataset TD and its data structure descriptions. The context information collected in this step is preferably only related to information in the dataset TD itself. There is preferably no outside information included or used in this step at this time. Data structure description may be useful for context information, which may be organized according to entities. To specify data structure, the semantics (that is, meaning of a given data element) and/or representation (format) of the data element may be used. The descriptive information may relate to a definition of primitive data type, such as int, string, float, date, datetime, etc. For complex data types, a further breakdown may be required.

At step S430 QID candidates of attributes in dataset TD are identified, based on the descriptive information as established at step S420. Such QID candidates may be computed based on certain statistical algorithms, such as re-identifiability scores based on uniqueness and/or influence type scores, for example such as reported by Jipmin Jung et al in “Determination Scheme for Quasi Identifiers Using Uniqueness and Influence for De-Identification of Clinical Data”, published at arXiv:1804.04762, April 2018. Some such scores may be based on equivalence classes defined for one or more data tables. In this context, an equivalence class describes a set of records in a given data table(s) which are indistinguishable regarding the specified (candidate) QIDs. Generally, in step S430, the score or other measure computed quantifies a risk of identifiability or de-identification of some or each data element in some or each data table (entity). Preferably, this step may include removal or obfuscation of direct identifiers and sensitive data, because an attribute can only be classified into one of three categories, namely, direct identifier, quasi-identifiers, and sensitive attribute, as mentioned earlier. It is only or mainly QIDs that are of interest herein.

At step S440 attacker's background knowledge is identified. Background knowledge is represented by data elements from external data sources, external to the target dataset. It may be retrieved and stored in a storage, referred to herein as the attacker's background KB knowledge base. Attacker's profile may be used to identify, for example in a manual or automated internet search or other database retrieval operation, attacker's background knowledge data. The returned attacker's background knowledge data may represent relevant background knowledge based on the attacker's profile for example. Background knowledge is mainly envisaged herein to relate to external data/source that is available, eg, as public domain information. Preferably, the background knowledge may include information on target population and data structure of target dataset TD. Target population relates to the characteristics of data subjects that make up the target dataset TD. The target dataset may be considered a sample (subset) of the underlying target population. Accessibility to this background knowledge is in general closely related to the profile of attacker. The background knowledge, user profiles and their relationship may be maintained and managed in database system, such as the above-mentioned attacker's background base BKR.

At step S450, the identified background knowledge is contextualized relative to the target dataset. Step S450 may include matching the candidate QIDs as per step S430 to attributes of the attacker's background knowledge, preferably based on semantic similarity. The candidates of QIDs are derived from the target dataset, while the background knowledge stored in the knowledge base may relate to information collected and maintained at a different time, for different purposes, by a different entity, etc. And yet, the information in background knowledge data may still be harvested herein to establish QIDs proper thanks to the semantic matching. For example, the specific name/string of candidate QID might be different from the name of the same data element stored in the attacker's background data BK. But using NL processing, such as semantic matching, allows establishing a link between the candidate QIDs in the target dataset TD, and the attributes in the identified attacker's background data. NLP enabled similarity computing can be leveraged herein to match the same data element specified in differing natural language in different systems.

Step S460 includes modelling the contextualized attacker's background knowledge based on the subset XBK (the QIDs) as provided by step S450. For example, step S460 may operate collectively on the matched attributes from the attacker's background data and the (formerly candidate) QIDs from the target dataset TD. Modelling of the attacker's background knowledge may be done for each entity and/or derived entities. To build a model for a contextualized background knowledge in this step, an integrated model covering both the individual entities and the aggregated or derived background knowledge may be useful as this allows a precise way of specifying background at multiple levels, along with their relationships. At aggregated level, derived background knowledge may be modeled in addition. For example, the total number of the transactions for a particular user could be a derived background knowledge.

In more detail, modeling of entity/data table level mainly includes the respective matched/identified QIDs from step S450 for a given entity or a group (or all) entities of dataset TD. Optionally, a confidence level or likelihood could be paired with some or each QID. A given aggregated level may include derived QIDs or quantities, such as number of events (e.g., hospital visits, purchasing transactions, etc.). The entity levels models may be combined to obtain aggregated level models.

Discrete data structures may be used to model at entity or aggregated level. For example, tuples, graphs or trees may be used. Nodes of such structures may represent different QIDs, whilst edges between nodes may be thought of as model components that represent logical relationships between QIDs, such as “contains”, “replaced by”, “mutually exclusive”, etc. The trees, graphs of tuples at entity level may be combined to build more complex models at aggregated level. In examples, an entity level model may be represented as a tuple, that is, a collection of QDIs, optionally paired with a likelihood.

In examples, a tree/graph or multiple trees/graphs may be used for plural (such as all) entities of target dataset TD. There may be one such discrete structure per entity. Multiple such discrete structures may be combined/merged to form the background knowledge model at aggregated level. Thus, the final output of model building step S460 may include the aggregated level background knowledge model which may be thought of as a super-model comprising multiple sub-models (entity level models), preferably including a definition on such sub-models may or may not be combined. Each such sub-model may represent a separate knowledge chunk. Such knowledge chunks may or may not be combinable/mergeable for a given attacker DC, as provided for by the definitions. Such definitions may be further defined/re-defined by knowledge relaxation (see below at step S470). Examples of such definitions for such an aggregated level model may include relationships such as “mutually exclusive” or “combinable”. Thus, for example, the aggregated level model may prescribe that for representing a given attacker's background knowledge, either graph A or graph B is to be used, but not both. Alternatively, a combination of graph A and B may be called for, so one may consider both, graph A and graph B in some other instances. The final output of the aggregated level model for the attacker's background knowledge as output may be represented as connected or disconnected graphs or example. In some embodiments, entity level modelling may be sufficient, but for better because more precise/realistic modelling, both entity and aggregated level modelling is used herein.

At optional step S470 contextualized knowledge is relaxed, so as not to over-estimate the attacker knowledge and thus improve quality of the anonymized version TD's of the target set TD. Knowledge relaxing of the (contextualized) attacker's background knowledge may be based on predefined parameters. Knowledge relaxation is a mechanism to estimate how much background knowledge an attacker DC knows about a certain dimension of the dataset—For example, a threshold may be parameterized according to data format. For example, in a user online shopping dataset, setting a maximum number of transaction items that an attacker might know may be one example of a knowledge relaxation. This may be a reasonable assumption as it may appear in some contexts unlikely that an attacker knows each every online transaction of a target individual.

In embodiments, relaxing operation S470 may including knowledge chunking as mentioned earlier. For example, assume a data table relates to a consumer purchase history. Knowledge chunking may then be defined as is follows to restructure the set of QIDs or the definitions in the background knowledge model of the previous step S460:
Knowledge chunk #1: QIDs: Purchase Channel, Product Category, and SKU
Knowledge chunk #2: QIDs: The total number of purchased items (eg, a statistical result)
   Then, in a privacy model, relaxing may prescribe that respective QIDs for knowledge chunks #1 and #2 may not be combined, for example. Instead, each chunk #1,2 is processed independently from the other.

Outputs produced by steps of the above-described method in FIG. 4, in particular the QIDs established as step S450 including the matched attributes XBK from the external data KB, and or the background knowledge model as per step S470 based on such the QIDs, may be passed on in step S480 to anonymization operation step S510 as illustrated in flow chart FIG. 5. The anonymization operation may be privacy model-based, and may include the QIDs as defined by subset XBK and/or may include the background knowledge model. Based on the privacy model, certain fields and/or records of the target data TD are anonymized to yield the anonymized version TD's of the original dataset TD.

The components of the system SYS may be implemented as one or more software modules, run on one or more general-purpose processing units PU such a workstation or on a server computer.

Alternatively, some or all components of system SYS may be arranged in hardware such as a suitably programmed microcontroller or microprocessor, such an FPGA (field-programmable-gate-array) or as a hardwired IC chip, an application specific integrated circuitry (ASIC). In a further embodiment still, the system SYS may be implemented in both, partly in software and partly in hardware.

The different components of the system SYS may be implemented on a single data processing unit PU. Alternatively, some or more components are implemented on different processing units PU, possibly remotely arranged in a distributed architecture and connectable in a suitable communication network such as in a cloud setting or client-server setup, etc. For example, the contextualizer CTX may be implanted on one processing unit PU, whilst the anonymizer AN is implemented on another processing unit (not shown).

One or more features described herein can be configured or implemented as or with circuitry encoded within a computer-readable medium, and/or combinations thereof. Circuitry may include discrete and/or integrated circuitry, a system-on-a-chip (SOC), and combinations thereof, a machine, a computer system, a processor and memory, a computer program.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above-described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfill the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium (in particular, but not necessarily, a non-transitory medium), such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope. Such reference signs may be comprised of numbers, of letters or any of alphanumeric combination.

1. A system for facilitating anonymization of a target dataset, comprising:
a contextualizer configured to match, in a matching operation, one or more target attributes of the target dataset with one or more attributes of data representing a data consumer's background knowledge for the target dataset to generate a contextualized data consumer's background knowledge, representative of the data consumer's background knowledge relative to the target dataset; and
output interface configured to provide the contextualized data consumer's background knowledge data to an anonymizer for anonymizing the target dataset.

2. The system of claim 1, wherein the matching operation is based on a similarity measure.

3. The system of claim 2, wherein the similarity measure includes a natural language similarity measure.

4. The system of claim 1, further comprising a background knowledge model builder configured to construct a background knowledge model for the target dataset to model the data consumer's background knowledge relative to the target dataset, based on the contextualized data consumer's background knowledge.

5. The system of claim 1, wherein the target dataset comprises multiple data tables, and wherein the contextualized data consumer's background knowledge relates to a given one of such multiple data table, and/or to plural such data tables collectively.

6. The system of claim 4, wherein the target dataset comprises multiple data tables, and wherein the background knowledge model includes at least one part constructed per one data table, and/or at least one other part constructed per plural data tables.

7. The system of claim 1, further comprising a background knowledge relaxation facilitator configured to restructure the contextualized data consumer's background knowledge, based on a pre-defined set of one or more rules.

8. The system of claim 1, wherein the anonymizer configured to anonymize the target dataset based on the background knowledge model.

9. The system of claim 1, wherein the data representing data consumer's background knowledge is identified by the contextualizer based on at least a profile of the data consumer from a data library representing background knowledge.

10. The system of claim 1, wherein the one or more target attributes are identified by a dataset explorer based on one or more descriptive quantities that describe a data structure of the target dataset.

11. The system of claim 10, wherein the one or more descriptive quantities describe one or more statistical properties of the target dataset.

12. The system of claim 1, wherein the data representing data consumer's background knowledge is different from the target dataset.

13. The system of claim 1, wherein the contextualized data consumer's background knowledge is represented as one or more quasi-identifiers.

14. A computer-implemented method for facilitating dataset anonymization, comprising:
matching, in a matching operation, one or more target attributes of a target dataset with one or more attributes of data representing a data consumer's background knowledge for the target dataset to generate a contextualized data consumer's background knowledge, representative of the data consumer's background knowledge relative to the target dataset; and
providing the contextualized data consumer's background knowledge data to an anonymizer for anonymizing the target dataset.

15. The method of claim 14, wherein the matching operation is based on a similarity measure.

16. The method of claim 15, wherein the similarity measure includes a natural language similarity measure.

17. The method of claim 14, further comprising:
constructing, via a background knowledge model builder, a background knowledge model for the target dataset to model the data consumer's background knowledge relative to the target dataset, based on the contextualized data consumer's background knowledge.

18. The method of claim 14, wherein the target dataset comprises multiple data tables, and wherein the contextualized data consumer's background knowledge relates to a given one of such multiple data table, and/or to plural such data tables collectively.

19. The method of claim 17, wherein the target dataset comprises multiple data tables, and wherein the background knowledge model includes at least one part constructed per one data table, and/or at least one other part constructed per plural data tables.

20. A computer program product comprising a non-transitory computer readable medium, the computer readable medium having computer readable code embodied therein, the computer readable code being configured such that, on execution by a suitable computer or processor, the computer or processor is caused to:
match, in a matching operation, one or more target attributes of a target dataset with one or more attributes of data representing a data consumer's background knowledge for the target dataset to generate a contextualized data consumer's background knowledge, representative of the data consumer's background knowledge relative to the target dataset; and
provide the contextualized data consumer's background knowledge data to an anonymizer for anonymizing the target dataset.
